(19) United States
(12) Patent Application Publication
(10) Pub. No.: US 2018/0189847 A1
(43) Pub. Date: Jul. 5, 2018

(54) COMMODITY SALES DATA PROCESSING APPARATUS AND METHOD FOR CONFIRMING AGE OF CUSTOMER

(71) Applicant: TOSHIBA TEC KABUSHIKI KAISHA, Tokyo (JP)

(72) Inventor: Nobuyuki Takahashi, Tagata (JP)

(21) Appl. No.: 15/911,291

(22) Filed: Mar. 5, 2018

Related U.S. Application Data
(63) Continuation of application No. 14/614,539, filed on Feb. 5, 2015.

(30) Foreign Application Priority Data
Feb. 7, 2014 (JP) 2014-022212

(51) Int. Cl. G06Q 30/06

(52) U.S. Cl. CPC G06Q 30/0607

(57) ABSTRACT

A commodity sales data processing apparatus comprises an age-confirmation commodity determination module configured to determine whether or not a commodity needs age confirmation, a face information input module configured to input face information of a customer obtained from an image of a customer captured by an image capturing section, a face information storage section configured to store face information of customer whose age is above a predetermined age beforehand, and an age confirmation module configured to confirm, if the commodity needs age confirmation, that the age of the customer is above the predetermined age in a state that the age confirmation screen is not displayed on a display for customer if the face information input by the face information input module is consistent with one of the face information of customers stored in the face information storage section beforehand.

### CROSS-REFERENCE TO RELATED APPLICATIONS

This application is a Continuation of application Ser. No. 14/614,539 filed on Feb. 5, 2015, the entire contents of which are incorporated herein by reference.

This application is based upon and claims the benefit of priority from Japanese Patent Application No. 2014-022212, filed Feb. 7, 2014, the entire contents of which are incorporated herein by reference.

### FIELD

Embodiments described herein relate generally to a commodity sales data processing apparatus and a method for confirming a customer whose age is above a predetermined age.

### BACKGROUND

Conventionally, in a store such as a supermarket or a convenience store, in a case in which a commodity to be sold to a customer is an age-confirmation commodity that can only be sold to a customer whose age is above a predetermined age (for example, 20 years old), a screen for confirming age is displayed on a display for customer of a commodity sales data processing apparatus such as a POS (Point of Sales) terminal or a register and the like, and the age-confirmation commodity cannot be sold to the customer unless the customer carries out an operation on the screen displayed on the display for customer to confirm that his or her age is above 20 years old.

However, conventionally, the customer has to carry out the foregoing age-confirmation operation when purchasing an age-confirmation commodity even if a shop clerk can easily realize that the age of the customer is above 20 years old, which causes customers to irritate.

### BRIEF DESCRIPTION OF THE DRAWINGS

FIG. 1 is a perspective view illustrating the appearance of a POS terminal at an operator side according to one embodiment;

FIG. 2 is a perspective view illustrating the appearance of the POS terminal at a customer side according to the embodiment;

FIG. 3 is a block diagram illustrating the hardware constitution of the POS terminal;

FIG. 4 is a memory map illustrating an example of a face master file of a memory section of the POS terminal;

FIG. 5 is a memory map illustrating the constitution of a commodity master file of the memory section;

FIG. 6 is a memory map illustrating a part of the file structure of a RAM of the POS terminal;

FIG. 7 is a block diagram illustrating the functional components of the POS terminal;

FIG. 8 is a flowchart illustrating the control processing of the POS terminal;

FIG. 9 is a diagram illustrating one example of the display on the POS terminal; and

FIG. 10 is a diagram illustrating another example of the display on the POS terminal.

### DETAILED DESCRIPTION

In accordance with one embodiment, a commodity sales data processing apparatus comprises an age-confirmation commodity determination module configured to determine whether or not a commodity specified by commodity specification information input at the time a commodity sales processing is executed needs an age confirmation, a face information input module configured to input face information obtained from a face image of a customer captured by an image capturing device at the time the commodity sales processing is executed, a face information storage section configured to store the face information of customer whose age is above a predetermined age, and an age confirmation module configured to confirm, if the age-confirmation commodity determination module determines that the commodity needs an age confirmation, that the age of the customer is above the predetermined age in a state that an age confirmation screen is displayed on a display for customer in a case in which the face information input by the face information input module is not consistent with any of the face information of customers, stored in the face information storage section, whose age are above the predetermined age, or that the age of the customer is above the predetermined age in a state that the age confirmation screen is not displayed on the display for customer in a case in which the face information input by the face information input module is consistent with one of the face information of customers, stored in the face information storage section beforehand, whose age are above the predetermined age.

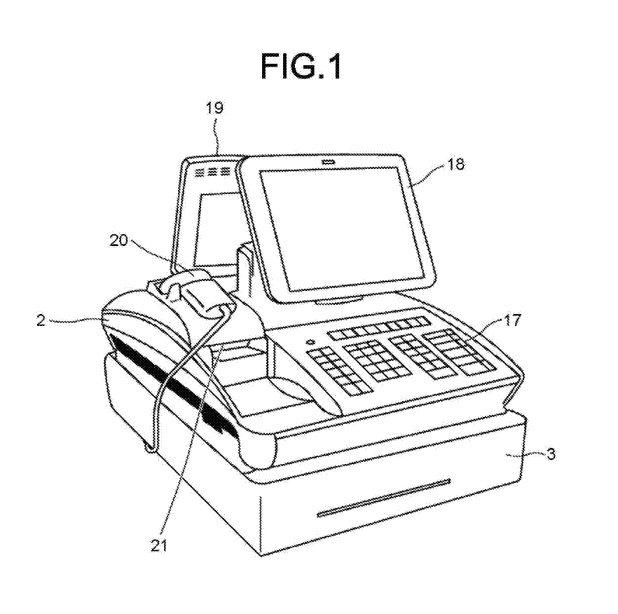

Hereinafter, the commodity sales data processing apparatus according to the embodiment is described in detail with reference to FIG. 1-FIG. 10.

In the embodiment, a POS terminal is described as the commodity sales data processing apparatus. However, the present invention is not limited to the embodiment described below.

FIG. 1 is a perspective view illustrating the appearance of the POS terminal according to the embodiment. The POS terminal is viewed at a side of an operator such as a shop clerk or a manager of the store.

In FIG. 1, a POS terminal 1 includes a main body 2 and a cash box 3. The cash box 3 equipped with a drawer stores cash such as bills and coins and marketable securities such as a gift voucher received from a customer, and change to be dispensed to a customer.

The main body 2 is provided with an operation section 17 such as a keyboard, a display for operator 18, e.g., a liquid crystal display device, and a display for customer 19, e.g., a liquid crystal display device.

The main body 2 includes a reading section 20 for reading a code symbol such as a barcode or a two-dimensional code attached to a commodity. The barcode or the two-dimensional code attached to the commodity is input through the reading section 20.

The main body 2 further includes a print section 21 for printing commodity information on a paper to issue a receipt.

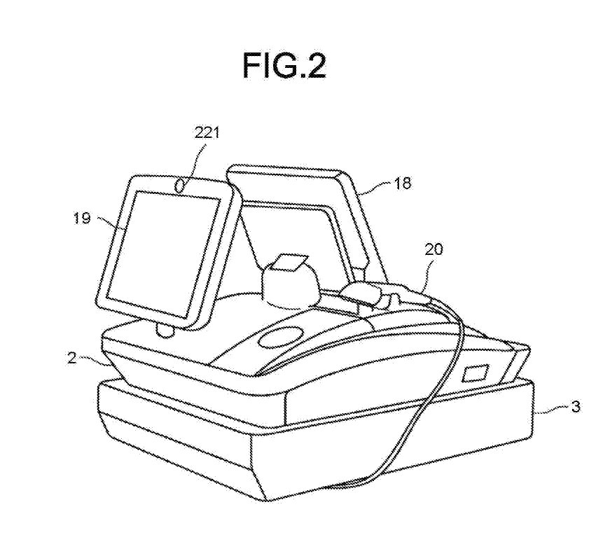

FIG. 2 is a perspective view illustrating the appearance of the POS terminal according to the embodiment. The POS terminal is viewed at a customer side.

In FIG. 2, a camera 221 consisting of a CCD (Charge Coupled Device) image sensor is arranged at the upper portion of the display surface of the display for customer 19.

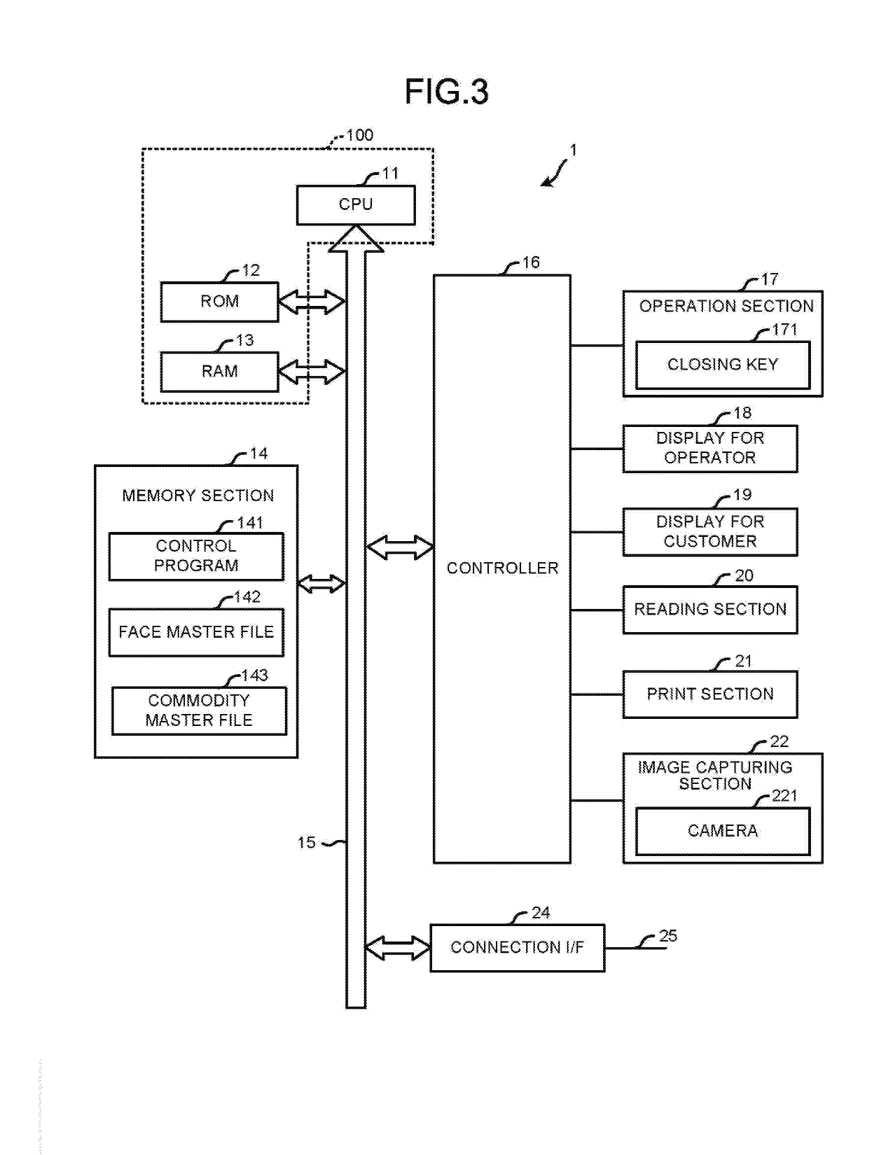

The camera 221 constitutes a part of an image capturing section 22 (refer to FIG. 3) which photographs the face of a customer standing at the customer side of the POS terminal 1.

Next, the hardware of the POS terminal 1 is described with reference to FIG. 3-FIG. 6.

FIG. 3 is a block diagram illustrating the hardware constitution of the POS terminal 1. In FIG. 3, the POS terminal 1 includes a CPU (Central Processing Unit) 11 serving as a main part of control, a ROM (Read Only Memory) 12 for storing various programs, a RAM (Random Access Memory) 13 for copying or decompressing various data, and a memory section 14 for storing various programs, which are connected with each other through a data bus 15.

The CPU 11, the ROM 12 and the RAM 13 constitute a control section 100. The control section 100 executes the later-described control processing by the CPU 11 which operates according to a control program 141 that is stored in the ROM 12 or the memory section 14 and copied or decompressed on the RAM 13.

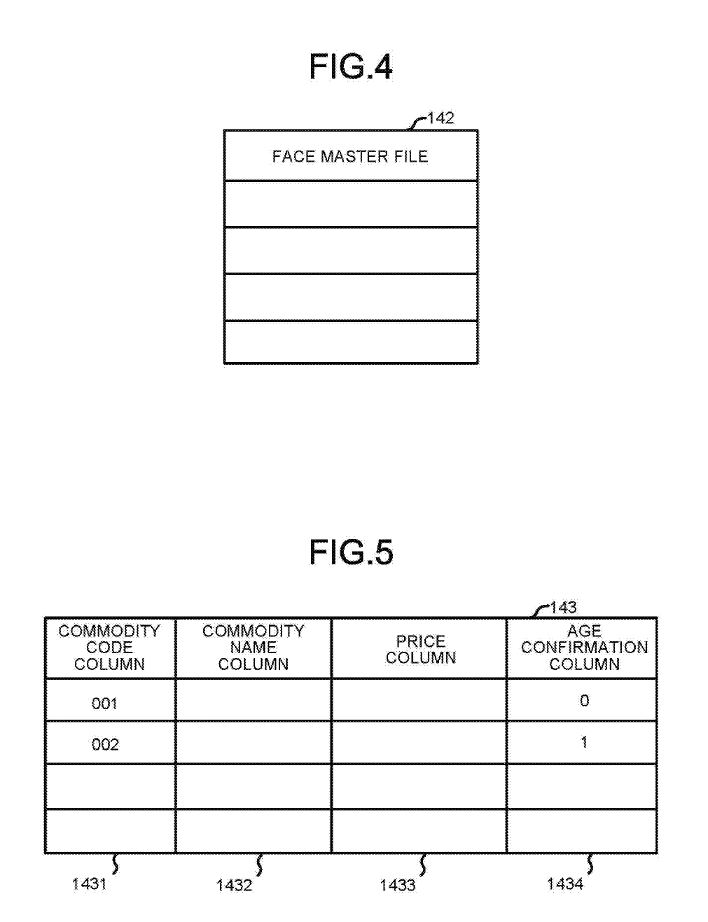

The memory section 14 is constituted with a nonvolatile memory such as a flash memory or an HDD (Hard Disc Drive) that keeps stored information even if the power source is cut off. The memory section 14 stores programs including the control program 141 and the like. In the present embodiment, the memory section 14 also stores a face master file 142 (refer to FIG. 4) and a commodity master file 143 (refer to FIG. 5).

The operation section 17, the display for operator 18, the display for customer 19, the reading section 20, the print section 21 and the image capturing section 22 are connected with the data bus 15 through a controller 16.

The operation section 17 is provided with various keys including a closing key 171, numeric keys, function keys and the like. The closing key 171 is operated when processing of one transaction is finished.

The display for operator 18 is arranged in such a manner that the display surface thereof is directed to the operator such as a shop clerk to display information and/or instruction to the operator.

The display for customer 19 is arranged in such a manner that the display surface thereof is directed to the customer to display information and/or message to the customer.

The reading section 20, consisting of a CCD image sensor and the like, reads the code symbol such as a barcode or a two-dimensional code attached to the commodity through the CCD to input the commodity code.

In the present embodiment, a handy type reading section 20 is used, and the operator closes or contacts the reading section 20 held in hand to or with the code symbol attached to the commodity to read the code.

The reading section 20 may be a scanner which emits light to scan the code symbol with a polygon mirror and the like and receives the light reflected from the code symbol.

The print section 21 includes, for example, a thermal printer having a thermal transfer type print head. The print section 21 takes out a rolled receipt paper housed in the main body 2, and prints commodity information, settlement information and the like on the receipt paper to issue the printed paper as a receipt.

The image capturing section 22 includes the camera 221 consisting of a CCD and the like. The camera 221 is arranged at the upper portion of the outer frame of the display for customer 19. The image capturing section 22 photographs an object (for example, customer) positioned in front of the camera 221.

The data bus 15 electrically connects a connection I/F (Interface) 24 with a store server (not shown) arranged in the store. The connection I/F 24 is connected with a line 25. The store server, which is electrically connected with all the POS terminals 1 arranged in the store, collects commodity information and settlement information from each POS terminal 1. The store server sends the commodity information and the settlement information collected from the POS terminals 1 to a main server (not shown) arranged in the headquarters.

FIG. 4 is a memory map illustrating the face master file 142 of the memory section 14. In FIG. 4, the face master file 142 stores, for each customer, face information of a customer who confirms that his/her age is above a predetermined age (20 years old in the embodiment) and agrees to record his/her face information obtained by recognizing the face of a customer from the face image of the customer captured by the image capturing section 22 through a face recognition technology. The face master file 142 only stores face information of the customer who confirms that his/her age is above 20 years old. The face information indicates the feature and relative relation for each part of the face (for example, shapes of eyes, nose, cheekbones, jaw and the like).

The face recognition technology, which is a well-known technology used to automatically identify a person from a captured digital image of face, recognizes a face in a way described below. For example, the noticeable feature is extracted from the captured face image to recognize the face. Specifically, parts of the face such as shape of eyes, nose, cheekbones and jaw, and the size and the relative position of the parts of the face are used as feature to recognize the face of a person. The feature information of each part of the face obtained through the face recognition technology is the face information.

FIG. 5 is a memory map illustrating the constitution of the commodity master file 143 of the memory section. In FIG. 5, the commodity master file 143 includes a commodity code column 1431, a commodity name column 1432, a price column 1433 and an age confirmation column 1434.

The commodity code column 1431 stores the commodity code for specifying the commodity. The commodity name column 1432 stores the commodity name of the commodity specified with the commodity code. The price column 1433 stores the unit price of the commodity specified with the commodity code.

The age confirmation column 1434 stores information indicating whether or not the commodity specified with the commodity code is an age-confirmation commodity. The age-confirmation commodity refers to a commodity that is only sold to customers whose ages are above the predetermined age. For example, in Japan, tobacco and alcoholic beverages and the like are age-confirmation commodities that can only be sold to customers above 20 years old (adult).

In the example shown in FIG. 5, “0 (zero)” is stored in the age confirmation column 1434 corresponding to the commodity having a commodity code “001”, which indicates that the commodity is not an age-confirmation commodity. The commodity code “001” is commodity specification information. On the contrary, “1 (one)” is stored in the age confirmation column 1434 corresponding to the commodity having a commodity code “002”, which indicates that the commodity is an age-confirmation commodity. The commodity code “002” is commodity specification information.

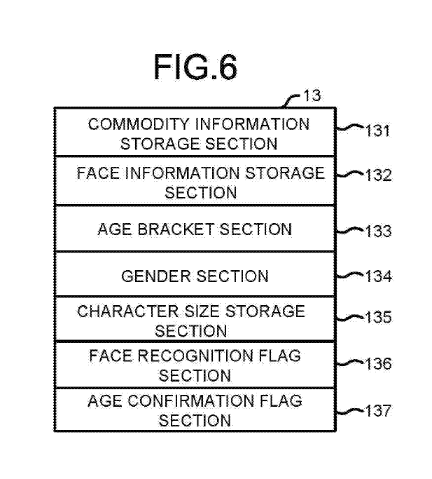

FIG. 6 is a memory map illustrating a part of the RAM 13. In FIG. 6, the RAM 13 includes a commodity information storage section 131, a face information storage section 132, an age bracket section 133, a gender section 134, a character size storage section 135, a face recognition flag section 136 and an age confirmation flag section 137.

The commodity information storage section 131 stores commodity information (such as a commodity code, commodity name, unit price, commodity attribution information and the like) read from the commodity master file 143 in association with the commodity code input based on the code symbol read by the reading section 20.

The face information storage section 132 stores face information of a customer, photographed by the image capturing section 22, to which the face recognition is performed.

The age bracket section 133 stores age bracket information of a customer determined through a well-known age determination technology based on the face information of the customer, photographed by the image capturing section 22, to which the face recognition is performed.

The well-known age determination technology is such a technology in which the face information of the customer is compared with face information of a number of customers stored in the past for each age bracket to determine which age bracket the customer belongs to.

The gender section 134 stores gender information of a customer determined through a well-known gender determination technology based on the face information of the customer, photographed by the image capturing section 22, to which the face recognition is performed. The well-known gender determination technology is such a technology in which the face information of the customer is compared with face information of a number of customers, classified in gender, which is stored in the past to determine the gender of the customer.

The character size storage section 135 stores character size that is suitable for the customer to display information on the display for customer 19 according to the age bracket information stored in the age bracket section 133. A large character size is stored so that large-sized characters are displayed for the customers in high age bracket.

The face recognition flag section 136 stores a face recognition flag “1” in a case in which the face information, photographed by the image capturing section 22, to which the face recognition is performed, is consistent with one of the face information stored in the face master file 142; and stores a face recognition flag “0” in a case in which the face information is not consist with any of the face information stored in the face master file 142.

The age confirmation flag section 137 stores an age confirmation flag “1” in a case in which it is confirmed that the age of the customer is above the predetermined age (20 years old in the embodiment); and stores an age confirmation flag “0” in a case in which it cannot be confirmed that the age of the customer is above the predetermined age.

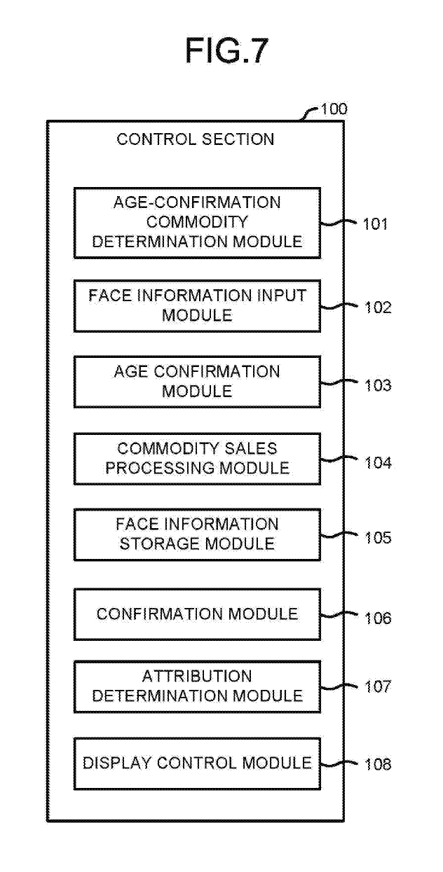

Next, the control processing of the POS terminal 1 is described with reference to FIG. 7-FIG. 10. FIG. 7 is a functional block diagram illustrating the functional components of the POS terminal. The control section 100 operates according to various programs including the control program 141 stored in the ROM 12 or the memory section 14 to function as an age-confirmation commodity determination module 101, a face information input module 102, an age confirmation module 103, a commodity sales processing module 104, a face information storage module 105, a confirmation module 106, an attribution determination module 107 and a display control module 108.

The age-confirmation commodity determination module 101 determines whether or not the commodity specified by the commodity specification information input at the time the commodity sales processing is carried out is a commodity that needs age confirmation.

The face information input module 102 inputs the face information obtained from the face image of the customer captured by the image capturing device at the time the commodity sales processing is carried out.

If the age-confirmation commodity determination module 101 determines that the commodity specified with the commodity specification information needs age confirmation, the age confirmation module 103 displays an age confirmation screen on the display for customer to confirm that the age of the customer is above the predetermined age if the face information input by the face information input module 102 is not consistent with any of the face information of the customers whose age are above the predetermined age pre-stored in the face information storage section. On the other hand, the age confirmation module 103 confirms that the age of the customer is above the predetermined age without displaying the age confirmation screen on the display for customer if the face information input by the face information input module 102 is consistent with one of the face information of the plurality of customers, stored in the face information storage section, whose age are above the predetermined age.

In a case in which the age-confirmation commodity determination module 101 determines that the commodity specified with the commodity specification information needs age confirmation, the commodity sales processing module 104 executes commodity sales processing based on the commodity specification information on condition that the age confirmation module 103 confirms that the age of the customer is above the predetermined age.

The face information storage module 105 cumulatively stores the input face information in the face information storage section in a case in which the age confirmation module 103 confirms that the age of the customer is above the predetermined age even if the input face information is not consistent with any of the face information of the plurality of customers, stored in the face information storage section beforehand, whose age are above the predetermined age.

The confirmation module 106 confirms that the face information input by the face information input module 102 is stored in the face information storage section.

The attribution determination module 107 determines the attribution of the customer based on the face information input by the face information input module 102.

The display control module 108 varies the display form of the information displayed on the display for customer based on the attribution of the customer determined by the attribution determination module 107 (for example, display with characters in a size suitable for the age bracket, or display of commercial message suitable for the age bracket/gender).

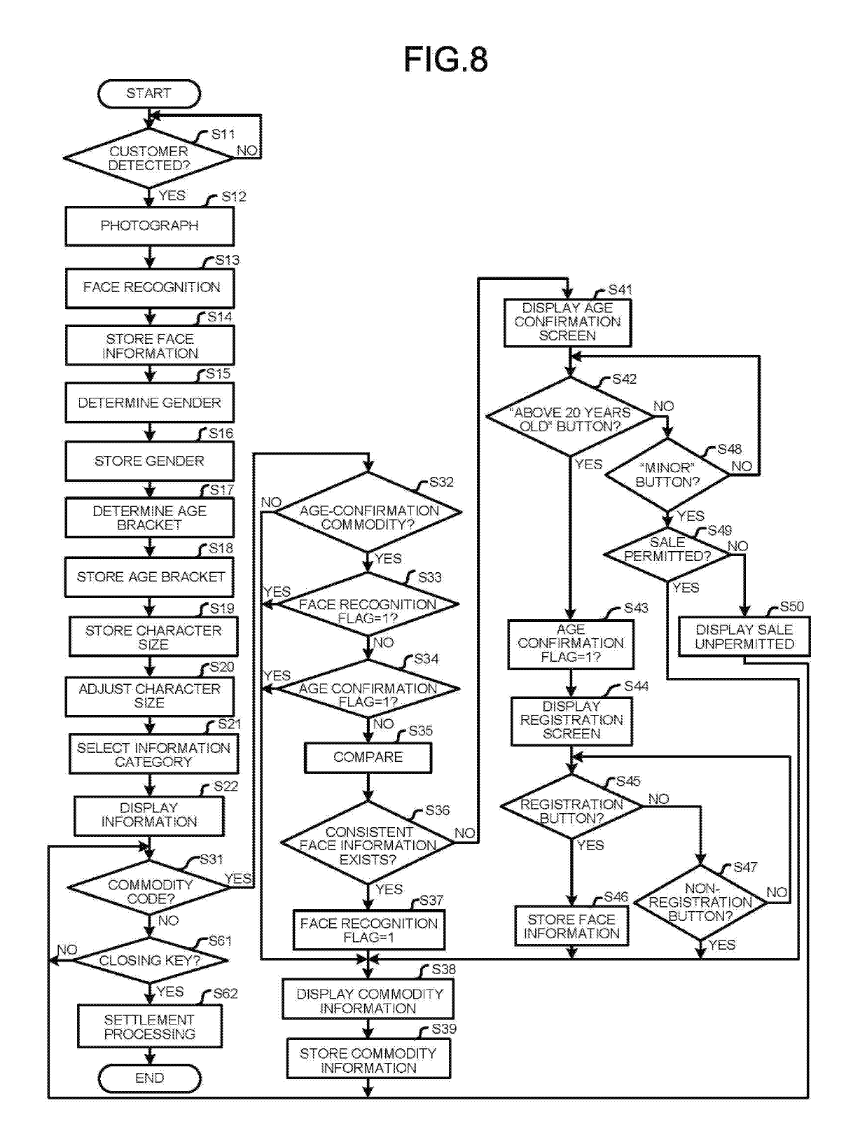

FIG. 8 is a flowchart illustrating the control processing of the POS terminal. In FIG. 8, the control section 100 determines whether or not a customer is detected (ACT S11). The customer is detected, for example, from the image captured by the image capturing section 22 or from the output of a well-known human sensor (not shown) arranged separately for detecting a human.

The control section 100 waits for until a customer is detected (NO in ACT S11). If it is determined that a customer is detected (YES in ACT S11), the control section 100 photographs the face of the customer by the image capturing section 22 (ACT S12). Then the control section 100 executes a face recognition based on the captured face image (ACT S13).

The control section 100 (face information input module 102) stores the face information obtained through the face recognition in the face information storage section 132 (ACT S14).

Next, the control section 100 determines the gender of the photographed customer based on the face information stored in the face information storage section 132 (ACT S15). The control section 100 stores the determined gender information in the gender section 134 (ACT S16).

The control section 100 determines the age bracket of the photographed customer based on the face information stored in the face information storage section 132 (ACT S17). The control section 100 stores the determined age bracket information in the age bracket section 133 (ACT S18).

The control section 100 further determines the character size of the information to be displayed on the display for customer 19 based on the age bracket information stored in the age bracket section 133 and stores the character size in the character size storage section 135 (ACT S19). Then the control section 100 (attribution determination module 107) adjusts the character size of the information to be displayed on the display for customer 19 according to the character size stored in the character size storage section 135 (ACT S20). In this case, the character size of the information displayed on the display for operator 18 is not changed. The character size of the information to be displayed on the display for operator 18 is set when the operator signs in to the POS terminal 1.

Next, the control section 100 (attribution determination module 107) selects the category of the information to be displayed on the display for customer 19 (ACT S21). The category of the information to be displayed on the display for customer 19 is selected based on the gender information stored in the gender section 134 and the age bracket information stored in the age bracket section 133. Then the control section 100 (display control module 108) displays the selected information on the display for customer 19 (ACT S22). In this way, for example, the information such as the commercial message suitable for the gender or the age bracket is automatically selected and then displayed on the display for customer 19.

Next, the control section 100 determines whether or not the commodity code is input (ACT S31). When the reading section 20 reads a code symbol such as a barcode or a two-dimensional code attached to the commodity, the commodity code contained in the code symbol is input.

If it is determined that the commodity code is input (YES in ACT S31), the control section 100 (age-confirmation commodity determination module 101) determines whether or not the commodity specified with the input commodity code is the age-confirmation commodity (ACT S32). In the present embodiment, the control section 100 determines whether or not the commodity specified with the input commodity code is the age-confirmation commodity with reference to the age confirmation column 1434 of the commodity master file 143. The control section 100 determines that the commodity specified with the commodity code “001” (commodity specification information) in the commodity code column 1431 is not an age-confirmation commodity, on the one hand, because “0” is stored in the age confirmation column 1434 commodity, and the control section 100 determines that the commodity specified with the commodity code “002” in the commodity code column 1431 is an age-confirmation commodity, on the other hand, because “1” is stored in the age confirmation column 1434.

If it is determined that the commodity is an age-confirmation commodity (YES in ACT S32), the control section 100 further determines whether or not the face recognition flag stored in the face recognition flag section 136 is “1” (determining whether the face recognition flag is “1” or “0”) (ACT S33). If it is determined that the face information stored in the face information storage section 132 is not consistent with any of the plurality of face information stored in the face master file 142 (NO in ACT S33), the control section 100 still further determines whether or not the age confirmation flag stored in the age confirmation flag section 137 is “1” (ACT S34).

If the age confirmation flag stored in the age confirmation flag section 137 is “1”, the control section 100 determines that it is confirmed that the customer is above 20 years old. If the age confirmation flag stored in the age confirmation flag section 137 is “0”, the control section 100 determines that it is not confirmed that the customer is above 20 years old.

If it is determined that the age confirmation flag is “0” (NO in ACT S34), the control section 100 compares the face information stored in the face information storage section 132 with the plurality of face information stored in the face master file 142 (ACT S35). Then the control section 100 determines whether or not the face information stored in the face information storage section 132 is consistent with one of the face information stored in the face master file 142 upon the comparison result (ACT S36).

If it is determined that the face information stored in the face information storage section 132 is consistent with one of the face information stored in the face master file 142 (YES in ACT S36), the control section 100 determines that the face information stored in the face information storage section 132 is the one of the face information stored in the face master file 142, and stores in the face recognition flag section 136 a face recognition flag “1” indicating that there is a consistent face information in the face master file 142 (ACT S37). In this way, it is confirmed that the customer represented with the face information stored in the face information storage section 132 is above 20 years old.

Next, the control section 100 displays the commodity information read from the commodity master file 143 based on the commodity code input in ACT S31 on both the display for operator 18 and the display for customer 19 (ACT S38). The control section 100 (commodity sales processing module 104) stores the read commodity information in the commodity information storage section 131 (ACT S39). Then the control section 100 returns to the processing in ACT S31 and waits for.

On the other hand, if it is determined that the face information stored in the face information storage section 132 is not consistent with any of the plurality of face information stored in the face master file 142 (NO in ACT S36), the control section 100 displays an age confirmation screen 191 on the display for customer 19 to confirm that the age of the customer is above 20 years old (ACT S41).

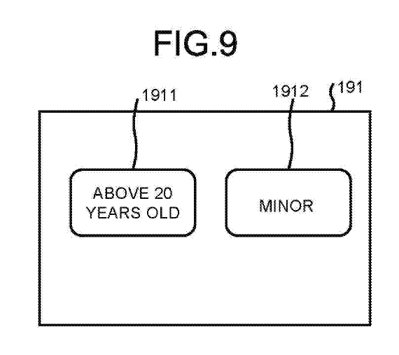

FIG. 9 is a diagram illustrating one example of the age confirmation screen 191 displayed on the display for customer 19. In FIG. 9, an “above 20 years old” button 1911 that is operated (pressed) by the customer of which the age is above 20 years old and a “minor” button 1912 that is operated (pressed) by the customer (minor) of which the age is below 20 years old are displayed on the age confirmation screen 191. The customer looks at the age confirmation screen 191 displayed on the display for customer 19, and operates the “above 20 years old” button 1911 if his/her age is above 20 years old, or operates the “minor” button 1912 if the age is below 20 years old.

A touch panel (not shown) is arranged on the display surface of the display for customer 19. When the customer touches at the location on the touch panel at which the “above 20 years old” button 1911 or the “minor” button 1912 is displayed, the control section 100 recognizes that the “above 20 years old” button 1911 or the “minor” button 1912 is operated.

It is not limited to the example shown in FIG. 9 in which the “above 20 years old” button 1911 and the “minor” button 1912 are displayed on the age confirmation screen 191. For example, it is applicable to display a message “above 20?” for confirming whether or not the customer is above 20 years old and an “OK” button operated if the age is above 20 on the age confirmation screen 191. In this case, if the “OK” button is pressed, it is determined that the customer is above 20 years old; otherwise, it is determined that the customer is a minor.

Return to the description on FIG. 8. The control section 100 determines whether or not the “above 20 years old” button 1911 is operated (ACT S42). If it is determined that the “above 20 years old” button 1911 is operated (YES in ACT S42), the control section 100 stores an age confirmation flag “1” in the age confirmation flag section 137 (ACT S43). Checking the age confirmation flag, it can be confirmed that the customer is above 20 years old. Then the control section 100 displays, on the display for customer 19, a face information registration screen 192 for displaying a message that asks the customer for the permission to register his/her face information into the face master file 142. If the customer permits the registration of his/her face information, display of the age confirmation screen 191 on the display for customer 19 is skipped from the next time even if a commodity code of an age-confirmation commodity is input (ACT S44).

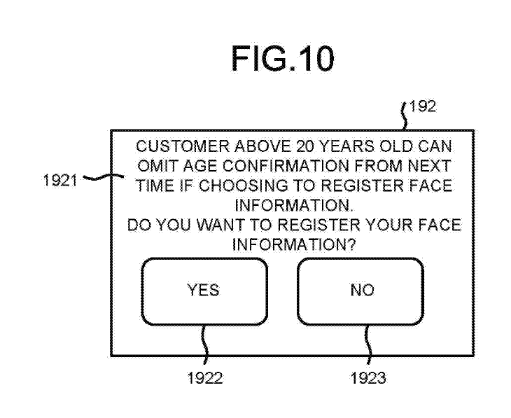

FIG. 10 is a diagram illustrating an example of the face information registration screen 192. In FIG. 10, a statement 1921 explaining for the registration of the face information into the face master file 142, a registration button 1922 that is operated by a customer who assents to the registration of his/her face information and, a non-registration button 1923 that is operated by a customer who does not assent to the registration of his/her face information are displayed on the face information registration screen 192. The customer looks at the face information registration screen 192, and operates one of the registration button 1922 and the non-registration button 1923.

Return to the description on FIG. 8. The control section 100 (confirmation module 106) determines whether or not the registration button 1922 is operated (ACT S45). If it is determined that the registration button 1922 is operated (YES in ACT S45), the control section 100 (face information storage module 105) stores his/her face information stored in the face information storage section 132 in the face master file 142 newly (ACT S46). Then the control section 100 executes the processing in ACT S38 and ACT S39, and then returns to the processing in ACT S31 and waits for.

On the other hand, if it is determined that the registration button 1922 is not operated (NO in ACT S45), the control section 100 determines whether or not the non-registration button 1923 is operated (ACT S47). If it is determined that the non-registration button 1923 is operated (YES in ACT S47), the control section 100 executes the processing in ACT S38 and ACT S39, and then returns to the processing in ACT S31 and waits for.

If it is determined that the non-registration button 1923 is not operated (NO in ACT S47), the control section 100 returns to the processing in ACT S45 and waits for.

In ACT S42, if it is determined that the “above 20 years old” button 1911 is not operated (NO in ACT S42), the control section 100 determines whether or not the “minor” button 1912 is operated (ACT S48). If it is determined that the “minor” button 1912 is operated (YES in ACT S48), the control section 100 determines whether or not the sale of the age-confirmation commodity is permitted (ACT S49). Further, if it is determined that the “minor” button 1912 is not operated (NO in ACT S48), the control section 100 returns to the processing in ACT S42 and waits for.

There is a case in which the customer wants to purchase the age-confirmation commodity for some reason even though he/she is a minor. For example, the minor is asked by an adult to purchase the age-confirmation commodity or the minor purchases the age-confirmation commodity as a gift item. In these cases, the shop clerk (operator) of the POS terminal 1 asks the minor customer the reason for purchasing the age-confirmation commodity, and there may be a case in which the shop clerk sells the age-confirmation commodity to the minor customer if the reason is acceptable. In this case, the operator operates a sales permission button (not shown) arranged on the operation section 17. The control section 100 determines that the sale of the age-confirmation commodity is permitted upon the operation of the sales permission button.

If it is determined that the sale of the age-confirmation commodity is permitted (YES in ACT S49), the control section 100 executes the processing in ACT S38 and ACT S39, and then executes the sales processing of the age-confirmation commodity.

On the other hand, if it is determined that the sale of the age-confirmation commodity is not permitted (NO in ACT S49), the control section 100 displays a message indicating that the commodity cannot be sold because of an age-confirmation commodity on the display for operator 18 and the display for customer 19 (ACT S50).

Then the control section 100 returns to the processing in ACT S31 and waits for, without executing the commodity information processing of the commodity purchased by the customer. This is because that it cannot be confirmed that the customer is above 20 years old and the commodity is an age-confirmation commodity.

In the present embodiment, the processing in ACT S41-ACT S50 is the age confirmation module.

In ACT S32, if it is determined that the commodity is not an age-confirmation commodity (NO in ACT S32), the commodity is a general commodity that needs no age confirmation, thus, the control section 100 executes the processing in ACT S38 and ACT S39 to carry out the commodity information processing without executing a series of age confirmation processing.

In ACT S33, if it is determined that the face recognition flag is “1” (YES in ACT S33), the control section 100 executes the processing in ACT S38 and ACT S39 without confirming whether or not the age of the customer is above 20 years old for the age-confirmation commodity. This is because that, as stated above, the face recognition flag “1” indicates that the face information of the customer is consistent with one of the face information of a plurality of customers above 20 years old stored in the face master file 142 and thus, it is already confirmed in the present transaction that he/she (customer) is above 20 years old.

In ACT S34, if it is determined that the age confirmation flag is “1” (YES in ACT S34), the “above 20 years old” button 1911 is operated by the customer and it is already confirmed that the age of the customer is above the predetermined age (20 years old). Therefore, the control section 100 executes the processing in ACT S38 and ACT S39 to carry out the commodity information processing without confirming whether or not the customer is above 20 years old again.

Further, in ACT S31, if it is determined that the commodity code is not input (NO in ACT S31), the control section 100 determines whether or not the closing key 171 of the operation section 17 is operated (ACT S61). If it is determined that the closing key 171 is operated (YES in ACT S61), the control section 100 executes a settlement processing based on the commodity information stored in the commodity information storage section 131 and the deposit or received amount information input through the operation section 17 (ACT S62). In the settlement processing, the total amount, the change amount and the like are calculated and displayed on the display for operator 18 and the display for customer 19, and the commodity information, the settlement information and the like are printed by the print section 21 to issue a receipt. Then the control section 100 terminates the processing.

On the other hand, if it is determined that the closing key 171 is not operated (NO in ACT S61), the control section 100 returns to the processing in ACT S31 and waits for.

In accordance with the present embodiment, the face information of the customer is compared with the face information of the customers, stored in the face master file 142, whose age are above the predetermined age (20 years old in the embodiment), and if there is a face information consistent with the face information of the customer, the commodity information processing is executed without performing the age confirmation processing in which the age confirmation screen 191 is displayed to confirm the age of the customer. Thus, the customer above 20 years old does not need to carry out age confirmation operation when purchasing an age-confirmation commodity.

Further, in accordance with the present embodiment, it is possible to cumulatively store in the face master file 142 face information of customer whose age is confirmed as above 20 years old upon the operation of only the “above 20 years old” button 1911. Thus, the face information can be stored in the face master file 142 through an easy operation.

Still further, in accordance with the present embodiment, the age bracket and the gender of the customer is determined based on the face information obtained through the face recognition, and thus, it is possible to display information in a character size suitable for the customer or to provide information such as a commercial message and the like suitable for the customer.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, it is exemplified in the present embodiment that the face master file 142 is stored in the memory section 14 of the POS terminal 1. However, the face master file 142 may be stored in the store server or the headquarters server (none is shown) mentioned above. In this case, the POS terminal 1 sends the face information together with a command indicating that the face information is stored to the store server or the headquarters server in ACT S46.

In the present embodiment, the predetermined age is specified as 20 years old. However, for example, other ages such as 18 years old, 15 years old, 30 years old and the like may be specified as a predetermined age.

Further, in the present embodiment, the processing in ACT S41-ACT S50 is specified as the age confirmation module, however, the present invention is not limited to this. For example, the processing in ACT S43-ACT S45 and the processing in ACT S47, or the processing in ACT S49 may be omitted from the age confirmation processing.

Still further, in the present embodiment, the description is made, using the handy type reading section 20. However, the reading section 20 may be a scanner which scans the code symbol with light emitted through a polygon mirror and the like and receives the light reflected from the code symbol.

The programs executed in the commodity sales data processing apparatus of the present embodiment are recorded in a computer-readable recording medium such as CD-ROM, flexible disk (FD), CD-R, DVD (Digital Versatile Disk) and the like in the form of installable or executable file.

Further, the programs executed in the commodity sales data processing apparatus of the present embodiment may be stored in a computer connected with a network such as the Internet, and downloaded via the network. Further, the program executed in the commodity sales data processing apparatus of the present embodiment may also be provided or distributed via a network such as the Internet.

The programs executed in the commodity sales data processing apparatus of the present embodiment may also be installed in the ROM in advance.

What is claimed is:

1. A display control device, comprising:
face information storage that stores therein face information of customers of predetermined age or above;
a memory that stores therein computer-executable programs; and
a hardware processor communicatively coupled to the memory and configured to:
determine whether or not a commodity, specified by commodity specification information input at a time of a commodity sales processing, needs an age confirmation;
input face information obtained from a face image of a customer captured by an image capturing device at the time of the commodity sales processing;
upon determining that the commodity needs an age confirmation,
when the input face information is consistent with the face information of one of the customers stored in the face information storage,
determine that the input face information is of a customer of the predetermined age or above; and
when the input face information is not consistent with the face information of any of the customers stored in the face information storage,
display an age confirmation screen on a display for the customer to allow the customer of the predetermined age or above to input onto the age confirmation screen and, on the basis of the customer's input, confirm that the age of the customer is the predetermined age or above, wherein
when the input face information is consistent with the face information of the one of the customers stored in the face information storage, the age confirmation is conducted for confirming that the age of the customer is the predetermined age or above without displaying the age confirmation screen on the display for the customer; and
when the input face information is not consistent with the face information of any of the customers of the predetermined age or above stored in the face information storage and when the age of the customer is confirmed to be the predetermined age or above, the input face information is stored in the face information storage, and wherein
upon determining that the commodity specified by the commodity specification information needs the age confirmation, the hardware processor is configured to execute commodity sales processing based on the commodity specification information on condition that the age of the customer is confirmed to be the predetermined age or above.

2. The commodity sales data processing apparatus according to claim 1, wherein
the hardware processor is configured to:
determine attribution of the customer based on the input face information, and
vary a display form of the information on the display for the customer based on the determined attribution of the customer.

3. The commodity sales data processing apparatus according to claim 1, wherein
the hardware processor is configured to determine whether to store the input face information in the face information storage.

4. The commodity sales data processing apparatus according to claim 1, wherein
the hardware processor is configured to display, when the input face information is not consistent with the face information of any of the customers stored in the face information storage, an age confirmation screen with an operation button on the display for the customer to allow the customer of the predetermined age or above to operate, and confirm that the age of the customer for the input face information is the predetermined age or above when the customer operates the operation button on the displayed age confirmation screen.

5. A method for confirming age of a customer, comprising:
determining whether or not a commodity, specified by commodity specification information input at a time of a commodity sales processing, needs an age confirmation;
inputting face information obtained from a face image of a customer captured by an image capturing device at the time of the commodity sales processing;
upon determining that the commodity needs an age confirmation,
when the input face information is consistent with the face information of one of customers stored in face information storage storing therein the face information of the customers of predetermined age or above,
determining that the input face information is of a customer of the predetermined age or above; and
when the input face information is not consistent with the face information of any of the customers stored in the face information storage,
displaying an age confirmation screen on a display for the customer to allow the customer of the predetermined age or above to input onto the age confirmation screen and, on the basis of the customer's input, confirming that the age of the customer is the predetermined age or above, wherein
when the input face information is consistent with the face information of the one of the customers stored in the face information storage, the age confirmation is conducted for confirming that the age of the customer is the predetermined age or above without displaying the age confirmation screen on the display for the customer; and
when the input face information is not consistent with the face information of any of the customers of the predetermined age or above stored in the face information storage and when the age of the customer is confirmed to be the predetermined age or above, the input face information is stored in the face information storage, and wherein
upon determining that the commodity specified by the commodity specification information needs the age confirmation, commodity sales processing is executed based on the commodity specification information on condition that the age of the customer is confirmed to be the predetermined age or above.
